(19) United States
(12) Patent Application Publication
(10) Pub. No.: US 2026/0357538 A1
(43) Pub. Date: Nov. 12, 2026

(54) A METHOD OF OPERATING A WORK VEHICLE ACCORDING TO A MAXIMUM ALLOWABLE SWING SPEED

(71) Applicant: Caterpillar SARL, Geneva (CH)

(72) Inventors: Chris Cesur, Kobe (JP); Sei Shimahara, Akashi (JP); Yasumasa Hoshino, Akashi (JP)

(21) Appl. No.: 19/139,647

(22) PCT Filed: Dec. 18, 2023
(86) PCT No.: PCT/EP2023/025532

§ 371 Date: Jun. 16, 2025

(30) Foreign Application Priority Data
Dec. 23, 2022 (GB) 2219639.8

(51) Int. Cl. E02F 9/12; E02F 3/32; E02F 9/24; E02F 9/26

(52) U.S. Cl. CPC E02F 9/123; E02F 9/128; E02F 9/24; E02F 9/26; E02F 3/32

(57) ABSTRACT

A method of operating a work vehicle is provided. The work vehicle comprises a swing apparatus rotatable about a swing axis, wherein the swing apparatus comprises an arm arrangement comprising a boom and a stick. The method comprises, by a control system, determining a moment of inertia of the swing apparatus and determining a maximum allowable swing speed of the swing apparatus rotating about the swing axis. The maximum allowable swing speed is based on the determined moment of inertia and a predetermined maximum angular stopping displacement. The method further comprises limiting a maximum operational swing speed of the swing apparatus to the maximum allowable swing speed.

### TECHNICAL FIELD

The present disclosure relates to a method of operating a work vehicle according to a maximum allowable swing speed, a controller configured to perform such a method and a work vehicle configured to be operated in accordance with such a method.

### BACKGROUND

Work vehicles or machines such as excavators or backhoe loaders have various degrees of freedom. One such degree of freedom is swing, which refers to the rotation of the main body relative to its undercarriage, or the rotation of an arm arrangement relative to the main body. Various features affect the swing characteristics, including the swing speed and swing acceleration of the work vehicle. For example, the position of its components, such as the position of an arm arrangement and/or tool, may alter a moment of inertia. This may affect the rate at which the swing speed can be increased or decreased. In addition, a configuration of the work vehicle, such as the type of tool attached, may affect the moment of inertia and therefore the rate at which the swing speed can be increased or decreased.

It is important that the swing speed can be reduced to zero within a certain distance or time to allow an operator to stop the swing quickly, such as when becoming aware of an obstruction or hazard within a safe distance.

In addition to this general requirement, European regulation EN 474 requires that a work vehicle, specifically an excavator, must be able to stop from full speed within a safe distance. The regulation previously required that this be accomplished with the most common configuration of the work vehicle. The European regulation EN 474 has been updated to require that a work vehicle must be able to stop within the safe distance in every available configuration.

### SUMMARY

An object of the present disclosure may be to provide a method of limiting the maximum operational swing speed of a work vehicle for allowing the work vehicle to reduce its swing speed to zero in a safe distance. A further object is to ensure that such a method operates across the different authorised configurations of the work vehicle. In addition, a further object is to ensure that such a method does not overly reduce the swing speed of the work vehicle. If the swing speed is overly reduced, an operator may notice this during single function and some multi-function operations.

The present disclosure is generally directed towards limiting the maximum operational swing speed of a swing apparatus of a work vehicle, such as the main body of an excavator, so that it can stop within a safe distance and/or angle. A control system is configured to determine the moment of inertia of the swing apparatus and determine the maximum swing speed which will allow the work vehicle to slow to zero within the safe distance, given the moment of inertia. This is then set as the maximum operational swing speed of the swing apparatus.

The maximum swing speed may be updated continuously as the moment of inertia of the work vehicle changes, by, for example, changing the position of an arm arrangement. Alternatively, the moment of inertia of the swing apparatus may be determined once for a configuration (e.g. a certain configuration of tool attached to the arm arrangement) based on the maximum moment of inertia possible for that configuration, and not updated as long as the vehicle has the same configuration. The maximum operational swing speed of the swing apparatus may be set as the maximum swing speed which will allow the work vehicle to slow to zero within the safe distance when it has the maximum moment of inertia possible for that configuration. Alternatively, the maximum operational swing speed of the swing apparatus may be adjusted based on the position of the arm arrangement without recalculating the moment of inertia.

The present disclosure provides a method of operating a work vehicle comprising a swing apparatus rotatable about a swing axis, wherein the swing apparatus comprises an arm arrangement comprising a boom and a stick. The method comprises, by a control system determining a moment of inertia of the swing apparatus and determining a maximum allowable swing speed of the swing apparatus rotating about the swing axis. The maximum allowable swing speed is based on the determined moment of inertia and a predetermined maximum angular stopping displacement. The method further comprises limiting a maximum operational swing speed of the swing apparatus to the maximum allowable swing speed.

The present disclosure further provides a controller for controlling a work vehicle comprising a swing apparatus rotatable about a swing axis, wherein the swing apparatus comprises an arm arrangement comprising a boom and a stick. The controller is configured to determine a moment of inertia of the swing apparatus and determine a maximum allowable swing speed of the swing apparatus rotating about the swing axis. The maximum allowable swing speed is based on the determined moment of inertia, and a predetermined maximum angular stopping displacement. The controller is further configured to limit a maximum operational swing speed of the swing apparatus to the maximum allowable swing speed.

The present disclosure further provides a work vehicle comprising a swing apparatus rotatable about a swing axis, wherein the swing apparatus comprises an arm arrangement comprising a boom and a stick, and a control system comprising the controller described above.

By way of example only, embodiments according to the present disclosure are now described with reference to, and as shown in, the accompanying drawings.

### BRIEF DESCRIPTION OF THE DRAWINGS

FIG. 1 is a side elevation of an embodiment of a system of the present disclosure;

FIG. 2 is a top elevation of the system of FIG. 1;

FIG. 3 is a schematic of a control system of the system of FIG. 1;

FIG. 4 is a flow diagram illustrating a method of limiting a maximum operational swing speed of a swing apparatus according to the present disclosure;

FIG. 5 is a flow diagram illustrating a method of determining a moment of inertia of a swing apparatus according to the present disclosure;

FIG. 6 is a flow diagram illustrating a further embodiment of the method of FIG. 4;

FIG. 7 is a flow diagram illustrating a method of determining a static moment of inertia of a swing apparatus according to the present disclosure;

FIG. 8 is a flow diagram illustrating a further embodiment of the method of FIG. 4; and

FIG. 9 is a graph illustrating a relationship between a component position and a maximum allowable swing speed of a swing apparatus according to the present disclosure.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements, including combinations of features from different embodiments, without departing from the scope of the invention. Specific details are given in the following description to provide a thorough understanding of the embodiments. However, it will be understood by one of ordinary skill in the art that embodiments may be practised without these specific details. For example, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

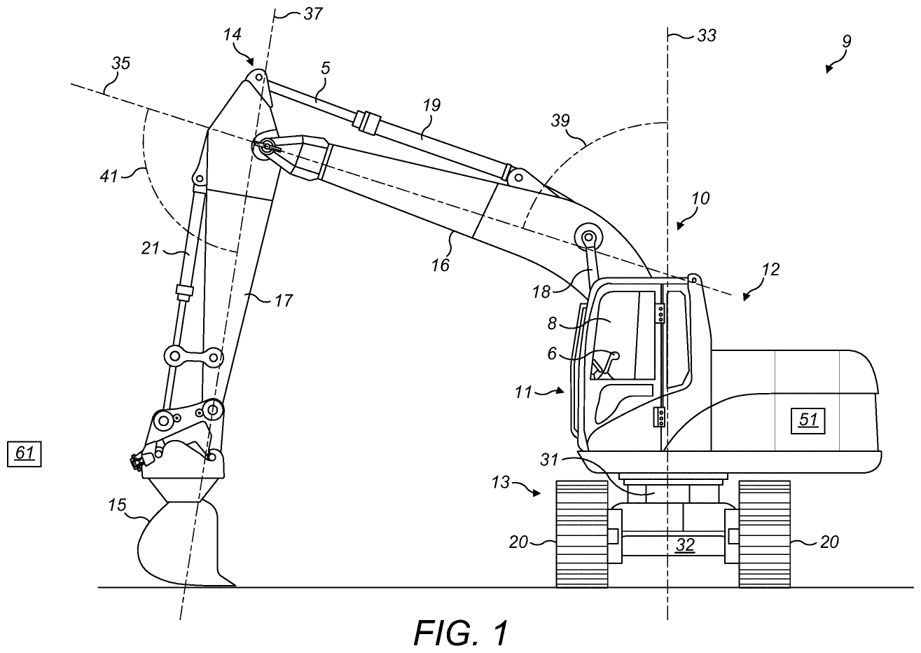

FIG. 1 illustrates an embodiment of a system 9 comprising a work vehicle 10, in this case an excavator. The work vehicle 10 may be any suitable type of work vehicle 10, including multi-purpose work vehicles, such as excavators, backhoes, loaders, dozers, shovels, fellers, harvesters, material handlers and other such work vehicles. The work vehicle 10 comprises a swing apparatus 11 and may comprise a swing base 13. The swing apparatus 11 comprises an arm arrangement 14. The swing apparatus 11 may comprise a main body 12. The swing base 13 may comprise an undercarriage 32 and/or a platform. The undercarriage 32 may comprise wheels or tracks 20. The main body 12 may comprise a cab 8 for an operator and a power unit (not shown) therein for providing power to the wheels or tracks 20.

The swing apparatus 11 may be attached to the swing base 13 via a swivel mount 31. The swivel mount 31 may allow the swing apparatus 11 to rotate in relation to the swing base 13. The swivel mount 31 may comprise a slip ring or a slewing ring. Rotation of the swing apparatus 11 relative to the swing base 13 may be actuated using a swing actuator 30. The swing actuator 30 may comprise a hydraulic motor or a hydraulic swivel.

The swing apparatus 11 is rotatable about a swing axis 33. The swing apparatus 11 may be able to rotate by 360 degrees relative to the swing base 13 about the swivel mount 31 and/or swing axis 33. The swing axis 33 may be perpendicular to the swing base 13 and/or may be perpendicular to a horizontal plane or the ground when the work vehicle 10 is on a level surface. The swing axis 33 may be a central axis of the swivel mount 31 and may be the axis of rotation of the swing apparatus 11 relative to the swing base 13 at the swivel mount 31.

The arm arrangement 14 comprises a boom 16 and a stick 17. The boom 16 and the stick 17 may be pivotally attached to one another. The boom 16 may be pivotally attached to the main body 12 at a first end of the boom 16. The stick 17 may be pivotably attached to the boom 16 at a second end of the boom 16 and a first end of the stick 17. A tool 15 may be connected to the arm arrangement 14. The tool 15 may be pivotably attached to the stick 17 at a second end of the stick 17. The arm arrangement 14 may comprise at least one hydraulic actuator 18, 19, 21 for controlling the orientation thereof. In particular, the arm arrangement 14 may comprise a boom hydraulic actuator 18 for controlling the orientation and movement of the boom 16. The arm arrangement 14 may comprise a stick hydraulic actuator 19 for controlling the orientation and movement of the stick 17. The arm arrangement 14 may comprise a tool hydraulic actuator 21 for controlling the orientation and movement of the tool 15.

The tool 15 may be of any suitable type. The tool 15 may, for example, be a bucket as illustrated or may be a grapple, tiltable bucket, tilt rotator, hammer, handling arm, multi-processor, pulveriser, saw, shears, blower, grinder, tiller, trencher, winch, auger, broom, cutter, planer, delimber, felling head, mulcher, or rake. The tool 15 may comprise a spray head or the like for providing a water spray during operation of the work vehicle 10, for example for dust suppression. The fluid may be pressurised hydraulic fluid, water or the like.

The work vehicle 10 may be operable in, configurable in and/or comprise at least one configuration. The configuration may refer to one or more of a swing apparatus 11 measurement; a swing base 13 measurement; a boom 16 measurement; a stick 17 measurement; a main body 12 measurement; a cab 8 measurement; a tool 15 measurement; and/or a type of tool 15. The aforementioned measurements may be a dimension measurement and/or a weight measurement. The dimension measurement may be a length, a width, a depth, an area, and/or a volume. The weight measurement may be a weight or a mass.

The work vehicle 10 may be orientable in and/or comprise a component position. The component position may comprise a boom 16 position; a stick 17 position; and/or a tool 15 position. The position may be defined by a component angle. The position may be defined by a component cylinder extension. The component position may comprise an arm arrangement 14 position, or a linkage position. Each configuration of the work vehicle 10 may be capable of having a plurality of different component positions.

The boom 16 may comprise a boom axis 35. The boom axis 35 may be an axis parallel to the direction along which the boom 16 extends for a majority of its length. The stick 17 may comprise a stick axis 37. The stick axis 37 may be an axis parallel to the direction along which the stick 17 extends for a majority of its length. A boom angle 39 may be the angle between the boom axis 35 and the swing axis 33. A stick angle 41 may be the angle between the boom axis 35 and the stick axis 37. The boom angle 39 and/or stick angle 41 may be used to define the component position. Global angles wherein the various axes are measured relative to the horizontal may be used to define the component position.

The boom, stick and tool hydraulic actuators 18, 19, 21 may each comprise a hydraulic cylinder and a piston rod. Hydraulic fluid may be supplied to the actuators to displace the rod relative to the cylinder. The boom hydraulic actuator 18 may comprise a boom hydraulic piston rod (not shown). The stick hydraulic actuator 19 may comprise a stick hydraulic piston rod 5. As the stick hydraulic piston rod and/or the stick hydraulic piston rod 5 are extended, the component position may change. A boom hydraulic piston rod extension and/or a stick hydraulic piston rod extension may be used to define the component position.

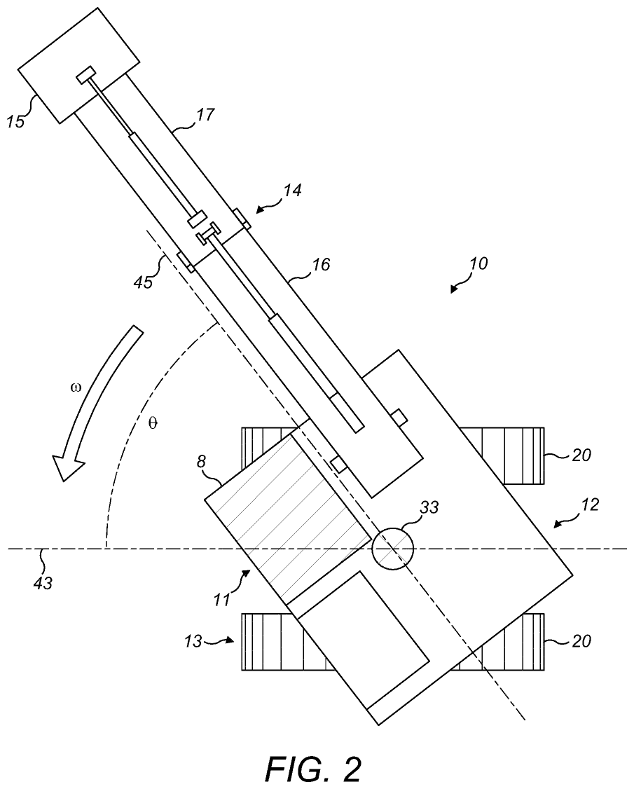

FIG. 2 provides an illustration of the work vehicle 10 of FIG. 1 in plan view, in which the swing axis 33 is illustrated as a point. The work vehicle may comprise a reference travel axis 43. The reference travel axis 43 may be substantially horizontal to the ground 33 lie in the same plane as the horizontal and may pass through and/or be perpendicular to the swing axis 33. The reference travel axis 43 may be parallel to the direction the work vehicle travels when the tracks 20 are actuated simultaneously with the same input. The reference travel axis 43 may be parallel to a direction the work vehicle 10 travels when a forward command is given.

The work vehicle 10 may comprise a swing apparatus axis 45. The swing apparatus axis 45 may lie in the same plane as the horizontal, and/or may lie in the same plane as the reference travel axis 43. The swing apparatus axis 45 may be parallel to a direction of extension of the arm arrangement 14 (as shown in FIG. 2) and may pass through and/or be perpendicular to the swing axis 33. The swing apparatus axis 45 may be parallel to a direction an operator faces while sitting in the cab 8.

The work vehicle 10 may comprise a swing angle θ. The swing angle θ may be defined as the angle measured between the reference travel axis 43 and the swing apparatus axis 45. When the swing angle θ is increased or decreased, the swing apparatus 11 may rotate around the swing axis 33 at a swing speed ω. The swing apparatus 11 may rotate relative to the swing base 13 at a swing speed ω. The swing apparatus 11 may rotate around the swing axis 33 in a swing direction (clockwise or anti clockwise). The swing speed w may be a swing velocity comprising the swing direction.

The work vehicle 10 may comprise a work vehicle fluid circuit (not shown) around which fluid may be circulated. The work vehicle 10 may comprise a controller 51 for controlling the work vehicle fluid circuit automatically or based upon inputs received from at least one input device 6 (shown in FIG. 1). The at least one input device 6 may comprise one or more of a joystick, a display 57, a touch screen, a button, or any suitable input device. The least one input device 6 may be used to operate the work vehicle 10. The work vehicle 10 may be operated to change the component position. The work vehicle fluid circuit may be connected to the at least one hydraulic actuator 18, 19, 21. Change the component position may comprise controlling the at least one hydraulic actuator 18, 19, 21 for pivoting of the arm arrangement 14 and the tool 15. The work vehicle 10 may be operated to increase or decrease the swing angle θ. The work vehicle fluid circuit may be connected to the swing actuator 30 and a swing brake 34 for controlling the swing of the swing apparatus 11 relative to the swing base 13.

The swing speed w may be controlled and/or affected by the least one input device 6. When an input to the least one input device 6 indicates an increase, the swing speed ω may increase. When the input to the input device 6 indicates a decrease, the swing speed w may decrease. When an input of 100% speed is provided to the at least one input device 6, the swing speed ω may increase towards a maximum operational swing speed of the work vehicle. When an input of 0% speed is provided to the at least one input device, the swing speed w may decrease towards a zero swing speed ω, or the swing speed w may remain at zero.

In order to decrease the swing speed ω, the system 9 may apply the swing brake 34 and/or may stop the application of torque by the swing actuator 30. The system 9 may apply the swing brake 34 to the swivel mount 31 and/or the swing actuator 30. The swing brake 34 may apply a brake torque τ_{b} in the opposite direction to the swing direction. The swing brake 34 may cause the swing speed ω to decrease. The swing brake 34 may cause the swing speed ω to decrease to zero.

For reasons of safety, it may be beneficial that the system 9 is able to reduce the swing speed ω to zero within a predetermined maximum angular stopping displacement θₛ. In addition, there are regulatory requirements that the system 9 is able to reduce the swing speed ω to zero within the predetermined maximum angular stopping displacement θₛ. The predetermined maximum angular stopping displacement θₛ may be a 90-degree angular displacement. It may be required that the system 9 is able to reduce the swing speed ω to zero from the maximum operational swing speed within a predetermined angular displacement. It may be required that the system 9 is able to reduce the swing speed ω to zero from the maximum operational swing speed within an angular displacement of 90 degrees. It may be required that the system 9 is able to reduce the swing speed ω to zero within the predetermined maximum angular stopping displacement θₛ regardless of the configuration and/or component position of the work vehicle 10. Instead of the predetermined maximum angular stopping displacement θₛ, a different metric, such as a predetermined maximum stopping time, may be used.

The swing apparatus 11 comprises a moment of inertia J. The moment of inertia J is the physical quantity of a body which represents the body's resistance to a change in angular speed. The moment of inertia J affects the ability of the system 9 to reduce the swing speed ω to zero within the predetermined maximum angular stopping displacement θₛ. A larger moment of inertia J results in a larger angular displacement required to reduce the swing speed ω to zero and results in a lower swing speed being required to so that the swing speed ω can be reduced to zero within the predetermined maximum angular stopping displacement θₛ.

The moment of inertia J may be linked to the brake torque τ_{b} and an angular deceleration experienced during braking by the following formula:

τ_{b}=Jα

Where α is the angular deceleration and is the rate of change of swing speed ω.

The moment of inertia J around an axis, may be defined as the sum of the products obtained by multiplying the mass of each particle of matter in a given body by the square of its distance from the axis. The moment of inertia J of the swing apparatus 11 may be higher when a tool 15 with a larger mass is attached to the arm arrangement 14 and may be lower when a tool 15 with a smaller mass is attached to the arm arrangement 14. The moment of inertia J of the swing apparatus 11 may be higher when the component position is such that the arm arrangement 14 extends by a longer distance from the swing axis 33 and may be lower when the component position is such that the arm arrangement 14 extends by a shorter distance from the swing axis 33. The moment of inertia J may constantly change when the work vehicle 10 is in use and is therefore not a known design parameter of the work vehicle 10.

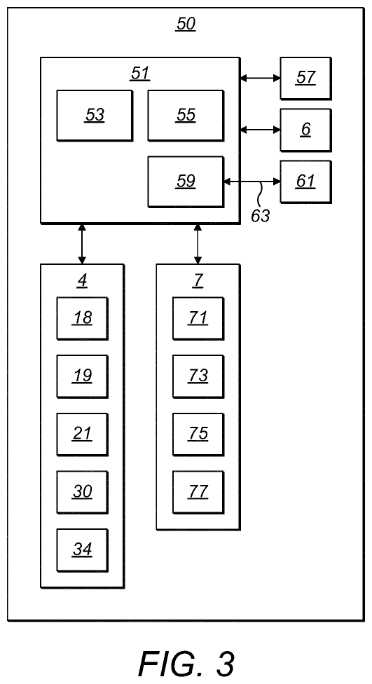

The system 9 may comprise a control system 50, which may be configured to perform the methods of the present disclosure. As illustrated in FIG. 3, the control system 50 may comprise the controller 51, which may comprise a memory 53, which may store instructions or algorithms in the form of data, and a processing unit 55, which may be configured to perform operations based upon the instructions. The controller 51 may be of any suitable known type and may comprise an engine control unit (ECU) or the like. The memory 53 may comprise any suitable computer-accessible or non-transitory storage medium for storing computer program instructions, such as RAM, SDRAM, DDR SDRAM, RDRAM, SRAM, ROM, magnetic media, optical media and the like. The processing unit 55 may comprise any suitable processor capable of executing memory-stored instructions, such as a microprocessor, uniprocessor, a multiprocessor and the like. The controller 51 may further comprise a graphics processing unit for rendering objects for viewing on the display 57 of the control system 50. The controller 51 may also be in communication with least one work vehicle communication module 59 for transferring data with an external computing system 61 via a wired or wireless network 63 (such as Ethernet, fibre optic, satellite communication network, broadband communication network, cellular, Bluetooth). The external computing system 61 may comprise computing systems, processors, servers, memories, databases, control systems and the like.

As summarised in FIG. 3, the system 9 may comprise at least one system actuator 4. The at least one system actuator 4 may comprise one or more of the boom, stick and tool hydraulic actuators 18, 19, 21, the swing actuator 30 and the swing brake 34.

The system 9 may comprise at least one sensor 7. The at least one sensor 7 may comprise one or more of a swing angle sensor 71, at least one movement or acceleration sensor 73, at least one component position sensor 75, a boom pressure sensor 77, an inertial measurement unit (IMU), an accelerometer, a gyroscope, a magnetometer, and a pressure sensor. In order to reduce complexity of the work vehicle 10, it may be beneficial to reduce the number of sensors necessary. For example, it may be beneficial for the work vehicle 10 to not include the swing angle sensor 71 if possible.

The controller 51 may be communicatively connected (via a wired or wireless connection) to the power unit, and any of the at least one system actuator 4 and/or at least one sensor 7 for providing control signals thereto and receiving sensor signals therefrom in order to control the operation of the work vehicle 10. The controller 51 may communicate with the input device 6, for receiving an input and controlling the work vehicle 10. The input device 6 may be in communication with the controller 51 for controlling the actuation of the swing actuator 30 and/or swing brake 34 to adjust the swing speed ω and/or adjust the swing angle θ of the swing apparatus 11. The input device 6 may increase or decrease the swing speed ω of the swing apparatus 11 relative to the swing base 13.

The controller 51 may receive operating condition data indicative of at least one operating condition of the work vehicle 10 by being communicatively coupled with the at least one sensor 7 and the at least one system actuator 4. The controller 51 may process the received operating condition data to determine further operating condition data and may store the operating condition data on the memory 53. The at least one operating condition and operating condition data may comprise at least one of:
The swing angle θ of the work vehicle 10, relative to the reference travel axis 43 (as shown in FIG. 2). The control system 50 may comprise a swing angle sensor 71 for determining the swing angle θ of the work vehicle 10;
The swing speed ω of the work vehicle 10. The control system 50 may comprise at least one movement or acceleration sensor 73 for determining the swing speed ω of the work vehicle 10;
The component position of the work vehicle 10. The control system 50 may comprise at least one component position sensor 75 for determining the component position of the work vehicle 10. The at least one component position sensor 75 may be mounted to the swing apparatus 11. The at least one component position sensor 75 may comprise at least one inertial measurement unit (IMU);
The boom position; stick position; and/or tool position of the work vehicle 10. The control system 50 may comprise at least one component position sensor 75 attached to the boom 16; stick 17 and/or tool 15 for determining the boom 16; stick 17; and/or tool 15 position of the work vehicle 10. The at least one component position sensor 75 may comprise at least one inertial measurement unit (IMU) attached to the boom 16; stick 17 and/or tool 15;
A component movement and/or acceleration of the work vehicle 10. The control system 50 may comprise at least one movement or acceleration sensor 73 for determining the component movement and/or acceleration of the work vehicle 10. The at least one movement or acceleration sensor 73 may be mounted to the swing apparatus 11. The at least one movement or acceleration sensor 73 may be at least one accelerometer;
A boom movement and/or acceleration; stick movement and/or acceleration; and/or tool movement and/or acceleration. The control system 50 may comprise at least one movement or acceleration sensor 73 attached to the boom 16; stick 17 and/or tool 15 for determining the boom 16; stick 17; and/or tool 15 movement and/or acceleration. The at least one movement or acceleration sensor 73 may comprise at least one accelerometer attached to the boom 16; stick 17 and/or tool 15;
The boom and/or stick angle of the work vehicle 10. The control system 50 may comprise the component position sensor 75, such as the IMU for determining the boom and/or stick angle of the work vehicle 10;
The boom and/or stick hydraulic piston rod extension of the work vehicle 10. The control system 50 may comprise the component position sensor 75, such as the IMU for determining the boom and/or stick hydraulic piston rod extension of the work vehicle 10;
A boom head end pressure of the work vehicle 10. The control system 50 may comprise a boom pressure sensor 77 within the boom hydraulic cylinder 18 for determining the boom head end pressure of the work vehicle 10;
The configuration of the work vehicle 10. The configuration of the work vehicle 10 may be input by an operator via the at least one input device 6; stored on the memory 53; and/or detected automatically using work vehicle sensors;
The brake torque τ_{b} of the swing brake 34 of the work vehicle 10. The brake torque τ_{b} may be input by an operator via at least one input device, stored on the memory 53 and/or estimated based upon a change in the component movement and/or acceleration upon application of the swing brake 34. The brake torque τ_{b} applied at any time may be based upon the input to the at least one input device 6. A 0% input to the at least one input device 6 may result in a maximum brake torque τ_{b,max} being applied by the swing brake 34;
An actuation torque τₐ of the swing actuator 30 of the work vehicle 10. The actuation torque τₐ may be input by an operator via at least one input device, stored on the memory 53 and/or estimated based upon a change in the component movement and/or acceleration upon application of the swing actuator 30. The actuation torque τₐ may be based upon the input to the at least one input device 6;
The maximum operational swing speed of the work vehicle. The maximum operational swing speed of the work vehicle may be determined according to the methods of this disclosure;
A maximum allowable swing speed ωₘₐₓ of the work vehicle. The maximum allowable swing speed ωₘₐₓ of the work vehicle may be determined according to the methods of this disclosure; and
The predetermined maximum angular stopping displacement θₛ. The predetermined maximum angular stopping displacement θₛ may input by an operator via at least one input device and/or stored on the memory 53. The predetermined maximum angular stopping displacement θₛ may be set by a regulatory and/or a safety requirement.

The operating condition data collected by the control system 50 may be transferred to the external computing system 61, which may perform the method of the present disclosure. Thus, the control system 50 may be considered in the present disclosure to comprise the external computing system 61, which may have instructions stored thereon for performing the methods disclosed herein in a similar manner to the controller 51.

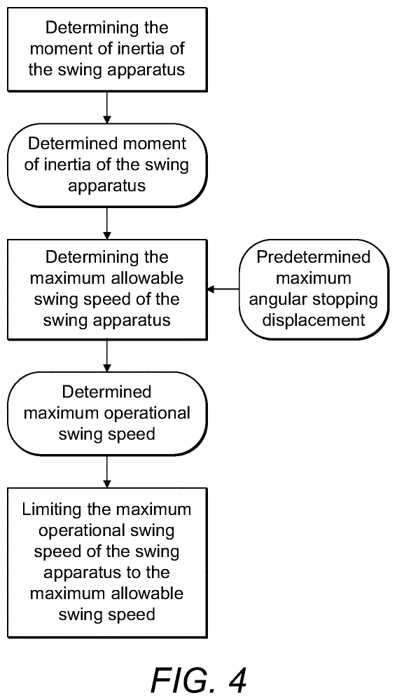

As shown in FIG. 4, a method of operating the work vehicle 10 comprises determining the moment of inertia J of the swing apparatus 11; determining the maximum allowable swing speed ωₘₐₓ of the swing apparatus 11 rotating about the swing axis 33; and limiting the maximum operational swing speed of the swing apparatus 11 to the maximum allowable swing speed ωₘₐₓ. The maximum allowable swing speed ωₘₐₓ is determined based on the determined moment of inertia J, and the predetermined maximum angular stopping displacement θₛ. The method is performed by the control system 50.

The maximum allowable swing speed ωₘₐₓ may be determined as the swing speed ω from which the swing apparatus 11 can slow to zero within the predetermined maximum angular stopping displacement θₛ, based upon the determined moment of inertia J. The maximum allowable swing speed ωₘₐₓ may be determined by comparing the moment of inertia J and the predetermined maximum angular stopping displacement θₛ to a look up table to find the appropriate maximum allowable swing speed ωₘₐₓ. The look up table may be prepared via experimentation and/or empirical methods to find the appropriate maximum allowable swing speed ωₘₐₓ for a given moment of inertia J and the predetermined maximum angular stopping displacement θₛ.

The maximum allowable swing speed ωₘₐₓ may be further based on the maximum brake torque τ_{b,max} of the work vehicle 10 for slowing the rotation of the swing apparatus 11 about the swing axis 33. The maximum allowable swing speed ωₘₐₓ may be calculated using the determined moment of inertia J, the maximum brake torque τ_{b,max} and the predetermined maximum angular stopping displacement θₛ according to the following formula:

$${ω}_{max} = \sqrt{2 \frac{{τ}_{b , max}}{J} {θ}_{s}}$$

The maximum allowable swing speed ωₘₐₓ may be determined using the determined moment of inertia J, the brake torque τ_{b} and the predetermined maximum angular stopping displacement θₛ by comparing the moment of inertia J, the brake torque τ_{b} and the predetermined maximum angular stopping displacement θₛ to a look up table to find the maximum allowable swing speed ωₘₐₓ. The look up table may be prepared via experimentation and empirical methods to find the appropriate maximum allowable swing speed ωₘₐₓ for a given moment of inertia J, brake torque τ_{b} and predetermined maximum angular stopping displacement θₛ.

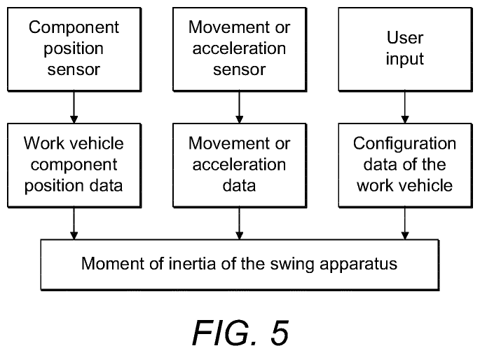

As shown in FIG. 5, the moment of inertia J of the swing apparatus 11 may be determined based on component position data, movement or acceleration data and/or configuration data of the work vehicle 10. The moment of inertia J of the swing apparatus 11 may be determined based upon sensor data from the at least one sensor 7.

The moment of inertia J of the swing apparatus 11 may be determined based upon work vehicle component position data from the at least one component position sensor 75. The work vehicle component position data may include boom position; stick position; and/or tool position data from the at least one component position sensor 75. The control system 50 may use the work vehicle component position data to calculate and/or model the moment of inertia J. The control system 50 may input the component position data into a simulation, computational model and/or digital twin of the work vehicle 10. The control system 50 may calculate and/or model the moment of inertia J of the simulation, computational model and/or digital twin. The control system 50 may calculate and/or model the moment of inertia J by summing of the products obtained by multiplying the mass of each particle of matter in swing apparatus 11 by the square of its distance from the swing axis 33. The control system 50 may estimate the moment of inertia J using the following formula:

J=m·r²

where m is the mass of each part of the swing apparatus and r is the distance of that part from the swing axis 33. The distance r may be calculated based on the work vehicle 10 dimensions and the component position. The control system 50 may then use the calculated and/or modelled moment of inertia J as the determined moment of inertia J for determining the maximum allowable swing speed ωₘₐₓ. The moment of inertia J may be determined using the component position data by comparing the component position data to a look up table to find the moment of inertia J. The look up table may be prepared via experimentation and empirical methods to find the correct moment of inertia J for given component position data.

The moment of inertia J of the swing apparatus 11 may be determined based upon movement or acceleration data from the at least one movement or acceleration sensor 73. The moment of inertia J of the swing apparatus 11 may be determined using torque data. The torque data may be data regarding a torque applied to cause the work vehicle to increase or decrease the swing speed ω. The torque may be the brake torque τ_{b} of the swing brake 34 and/or the actuation torque τₐ of the swing actuator 30. The torque data may include any resistive torque due to friction τ_{f}. The torque data may include a total torque TT equal to the sum of the torques. The moment of inertia J may be calculated as a moment of inertia necessary for the total torque applied at a certain time τ_{T,t} to result in an acceleration at that time αₜ. The moment of inertia J may be calculated using average values when the swing speed ω of the work vehicle 10 is changed from a first swing speed to a second swing speed within a swing angle by a total torque.

The moment of inertia J of the work vehicle 10 may be determined based upon configuration data of the work vehicle 10. The configuration data may be indicative of the dimensions and/or weight of at least part of the swing apparatus 11. The configuration data may be indicative of the configuration of the work vehicle 11. At least a portion of the configuration data may be obtained from a user input. The user may input to the input device 6 the type of tool 15 and/or the weight of the tool 15 attached to the arm arrangement 14. A variety of predetermined configurations may be supplied for a user to choose from. The user may be able to select one of the predetermined configurations using the at least one input device 6, such as display 57. The user may be able to create custom configurations for when the work vehicle 10 is used in a non-standard configuration and/or when the user uses a configuration not envisaged by a manufacturer of the work vehicle 10.

The control system 50 may input the configuration data into a simulation, computational model and/or digital twin of the work vehicle 10. The control system 50 may calculate and/or model the moment of inertia J of the simulation, computational model and/or digital twin. The control system 50 may calculate and/or model the moment of inertia J by summing of the products obtained by multiplying the mass of each particle of matter in the work vehicle 10 by the square of its distance from the swing axis 33. The control system 50 may then use the calculated and/or modelled moment of inertia J as the determined moment of inertia J for determining the maximum allowable swing speed ωₘₐₓ.

The moment of inertia J may be determined using artificial intelligence and/or machine learning techniques, such as a neural network and/or deep learning. The neural network may be trained using training data which includes component position data, movement or acceleration data, configuration data, and moment of inertia data. The training data may comprise input data comprising component position data, movement or acceleration data and configuration data. The training data may comprise target data comprising moment of inertia data. Since work vehicle behaviour may change overtime, artificial intelligence and/or machine learning techniques may account for such changes be being trained on new data.

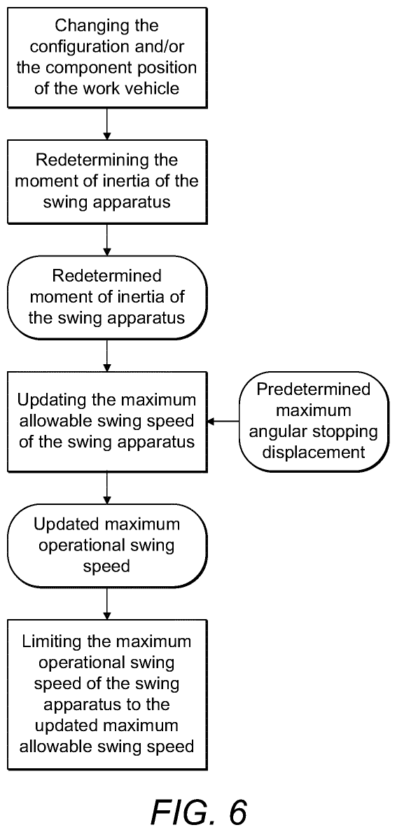

As shown in FIG. 6, the method may further comprise changing the configuration and/or the component position of the work vehicle 10; redetermining the moment of inertia J to determine a redetermined moment of inertia J₂ of the swing apparatus 11 in the changed configuration and/or changed component position; updating the maximum allowable swing speed ωₘₐₓ of the swing apparatus 11; and limiting the maximum operational swing speed of the swing apparatus 11 to the updated maximum allowable swing speed ω_{max,2}. The updated maximum allowable swing speed ω_{max,2} may be based on the redetermined moment of inertia J₂ and the predetermined maximum angular stopping displacement θₛ.

The method may comprise redetermining the moment of inertia J at a certain time interval. The moment of inertia J may be redetermined every 0.1 seconds, every 1 second, or every 10 seconds. The moment of inertia J may be redetermined after an input is received by the controller 51. The moment of inertia J may be dynamically redetermined and/or updated.

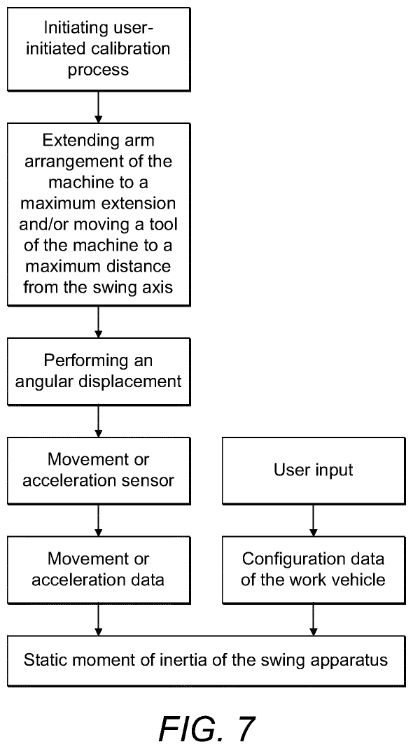

As shown in FIG. 7, the determined moment of inertia may be a static moment of inertia J static comprising a reference value determined based upon the configuration of the swing apparatus 11. Any given configuration of the work vehicle may have a single static moment of inertia J_{static}. The static moment of inertia J_{static} may be the maximum possible moment of inertia for the configuration of the swing apparatus. The static moment of inertia J_{static} may be determined as the moment of inertia when the arm arrangement 14 of the work vehicle 10 is at maximum extension and/or a tool 15 of the work vehicle 10 is at the maximum operational distance of the tool 15 from the swing axis 33. The method may further comprise the step of saving the static moment of inertia J static and/or the maximum allowable swing speed ωₘₐₓ to a data file in the memory 53 corresponding to a specific configuration. The static moment of inertia J_{static} may not be updated as the component position changes. The static moment of inertia J_{static} may be used to limit the maximum allowable swing speed ωₘₐₓ regardless of the component position, for a given configuration.

The static moment of inertia J_{static} may be determined based upon configuration data of the work vehicle 10 in the same manner as described above relating to the determination of the moment of inertia J.

The method may further comprise a user-initiated calibration process. The static moment of inertia J_{static} may be determined based upon sensor data from at least one sensor 7 during the user-initiated calibration process. The user-initiated calibration process may comprise determining the moment of inertia J after extending the arm arrangement 14 of the work vehicle 10 to a maximum extension and/or moving the tool 15 of the work vehicle 10 to a maximum distance from the swing axis 33 of the work vehicle 10; and performing an angular displacement. The static moment of inertia J_{static} may be determined based upon sensor data from at least one sensor 7 during the user-initiated calibration process in the same manner as described above relating to the determination of the moment of inertia J. The user-initiated calibration process may require the user to input a calibration command to the control system 50 upon which the control system 50 will extend the arm arrangement 14 to maximum extension and then perform the angular displacement whilst the sensor data is recorded. The user-initiated calibration process may require the user to follow prompts to extend the arm arrangement 14 to maximum extension and then perform the angular displacement while the control system 50 records the sensor data. The method may further comprise saving the static moment of inertia J_{static} to a data file in the memory 53 corresponding to a specific configuration.

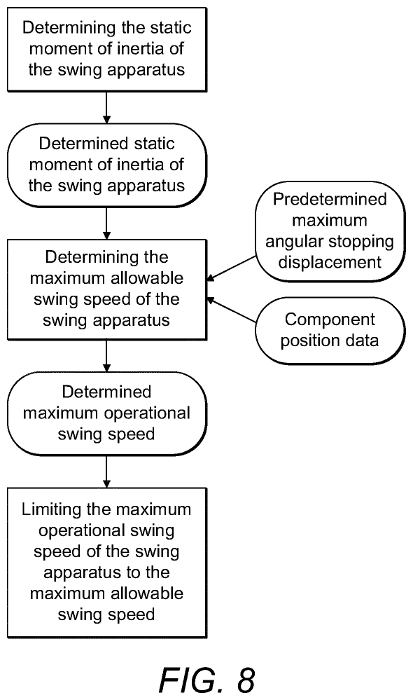

As shown in FIG. 8, the maximum allowable swing speed ωₘₐₓ may be further based on work vehicle component position data. The maximum allowable swing speed ωₘₐₓ may be further based on component position data without changing the value of the single static moment of inertia J_{static} used to limit the maximum allowable swing speed ωₘₐₓ. Using component position data to determine the maximum allowable swing speed ωₘₐₓ allows the change in moment of inertia J caused by changing the component position to be accounted for without recalculating the moment of inertia (which may be computationally expensive).

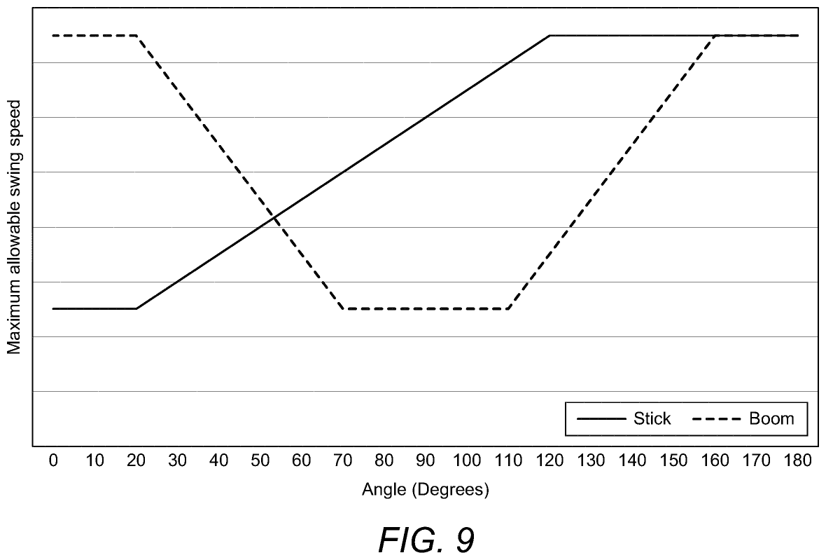

As illustrated in FIG. 9, component position data such as the stick angle 41 and/or boom angle 39 may be used to determine the maximum allowable swing speed ωₘₐₓ. As the stick angle 41 and/or boom angle 39 are adjusted, the moment of inertia J will be affected because the position of the arm arrangement 14 will change. The arm arrangement 14 may be adjusted such that is extends further from the swing axis 33, thereby increasing the moment of inertia J. The maximum allowable swing speed ωₘₐₓ can be adjusted based on the variation of stick angle 41 and/or boom angle 39 without recalculating the moment of inertia, by using the stick angle 41 and/or boom angle 39 as a direct input in determining the maximum allowable swing speed ωₘₐₓ.

As shown in FIG. 9, as the stick angle 41 increases, the maximum allowable swing speed ωₘₐₓ may increase. The stick angle 41 increasing may cause the extension of the arm arrangement 14 of the work vehicle 10 to reduce and/or a distance of the tool 15 from the swing axis 33 to reduce. This reduction may cause the moment of inertia J to reduce. A higher maximum allowable swing speed ωₘₐₓ may still allow the swing apparatus 11 to slow to zero within the predetermined maximum angular stopping displacement θₛ due to the reduced moment of inertia J. The maximum allowable swing speed ωₘₐₓ may be increased accordingly.

Above a certain stick angle, the maximum allowable swing speed ωₘₐₓ may be at an upper limit beyond which it is not increased. The upper limit may be set by safety considerations and/or vehicle limits. Below a certain stick angle, the maximum allowable swing speed ωₘₐₓ may be at a lower limit beyond which it is not decreased. The lower limit may be set as the swing speed ω from which the swing apparatus 11 can slow to zero within the predetermined maximum angular stopping displacement θₛ, given the static moment of inertia J_{static}. The stick angles 41 at which the maximum allowable swing speed ωₘₐₓ starts to increase, stops increasing, and the rate of increase may be selected via experimentation and empirical methods to find the appropriate maximum allowable swing speed ωₘₐₓ for a given static moment of inertia J_{static}, maximum angular stopping displacement θₛ, and stick angle 41.

As shown in FIG. 9, component position data such as the boom angle 39 may be used to determine the maximum allowable swing speed ωₘₐₓ. As illustrated, as the boom angle 39 increases, the maximum allowable swing speed ωₘₐₓ may decrease, then remain constant and then increase. The boom angle 39 increasing from small angles may cause the extension of the arm arrangement 14 of the work vehicle 10 to increase and/or a distance of the tool 15 from the swing axis 33 to increase. This increase may cause the moment of inertia J to increase. A lower maximum allowable swing speed ωₘₐₓ may be needed to allow the swing apparatus 11 can slow to zero within the predetermined maximum angular stopping displacement θₛ. The maximum allowable swing speed ωₘₐₓ may be decreased accordingly. The boom angle 39 increasing at angles around 90 degrees may not affect the extension of the arm arrangement 14 of the work vehicle 10 and/or a distance of the tool 15 from the swing axis 33. This may cause the moment of inertia J to remain roughly constant. A constant maximum allowable swing speed ωₘₐₓ may allow the swing apparatus 11 can slow to zero within the predetermined maximum angular stopping displacement θₛ. The maximum allowable swing speed ωₘₐₓ may be kept constant accordingly. The boom angle 39 increasing from angles around 90 degrees may cause the extension of the arm arrangement 14 of the work vehicle 10 to decrease and/or a distance of the tool 15 from the swing axis 33 to decrease. This increase may cause the moment of inertia J to decrease. A higher maximum allowable swing speed ωₘₐₓ may still allow the swing apparatus 11 can slow to zero within the predetermined maximum angular stopping displacement θₛ. The maximum allowable swing speed ωₘₐₓ may be increased accordingly.

Below a certain boom angle 39, and above a certain boom angle 39, the maximum allowable swing speed ωₘₐₓ may be at an upper limit beyond which it is not increased. The upper limit may be set by safety considerations and/or vehicle limits. Between two certain boom angles 39, the maximum allowable swing speed ωₘₐₓ may be at a lower limit beyond which it is not decreased. The lower limit may be set as the swing speed ω from which the swing apparatus 11 can slow to zero within the predetermined maximum angular stopping displacement θₛ, given the static moment of inertia J_{static}. The boom angles 39 at which the maximum allowable swing speed ωₘₐₓ starts to increase, stops increasing, and the rate of increase may be selected via experimentation and empirical methods to find the appropriate maximum allowable swing speed ωₘₐₓ for a given static moment of inertia J_{static}, maximum angular stopping displacement θₛ, and boom angle 39.

The method may further comprise the control system 50 rotating the swing apparatus 11 about the swing axis 33 at a swing speed ω equal to or less than the maximum operational swing speed ωₘₐₓ. The method may further comprise the control system 50 overriding a user command to rotate the swing apparatus 11 around the swing axis 33 at a swing speed ω greater than the maximum operational swing speed ωₘₐₓ. Overriding the user command may comprise receiving a user input to perform a rotation at a swing speed ω greater than the maximum operational swing speed ωₘₐₓ and outputting a command to the swing actuator 30 to perform a rotation at a swing speed ω equal to or less than the maximum operational swing speed ωₘₐₓ.

### INDUSTRIAL APPLICABILITY

The method 50 may thus determine the moment of inertia J of the swing apparatus 11 and use this value to determine an appropriate maximum allowable swing speed ωₘₐₓ. By using the moment of inertia J of the present configuration of the work vehicle 10, an appropriate maximum allowable swing speed ωₘₐₓ for this specific configuration is determined. Overly limiting the swing speed ω due to a potentially higher moment of inertia J of other configurations does not occur. The maximum allowable swing speed ωₘₐₓ is therefore based on the current configuration and so may always be maximised. This ensures that the work vehicle 10 is able to reduce its swing speed ω to zero in a safe distance, such as the predetermined maximum angular stopping displacement θₛ, across different configurations of the work vehicle 11. In addition, the swing performance of the work vehicle 11 is not unduly affected as it is always at a maximum safe speed for the current configuration.

If the method includes redetermining the moment of inertia J and updating the maximum allowable swing speed ωₘₐₓ upon a change in component position of the work vehicle 11, an appropriate maximum allowable swing speed ωₘₐₓ for this specific configuration and component position is determined. Overly limiting the swing speed ω due to a potentially higher moment of inertia J of other component positions does not occur. The maximum allowable swing speed ωₘₐₓ is therefore based on the current component position and so may always be maximised. This ensures that the work vehicle 10 is able to reduce its swing speed ω to zero in a safe distance, such as the predetermined maximum angular stopping displacement θₛ, across different component positions of the work vehicle 11. In addition, the swing performance of the work vehicle 11 is maximised as it is always at a maximum safe speed for the current component position.

If the method includes determining a static moment of inertia J_{static}, recalculating the moment of inertia J, which may be computationally expensive, is avoided. In an embodiment where the maximum allowable swing speed ωₘₐₓ is further based upon work vehicle component position data an appropriate maximum allowable swing speed ωₘₐₓ for this specific configuration and component position is determined without recalculating the moment of inertia J, which may be computationally expensive.

1. A method of operating a work vehicle comprising a swing apparatus rotatable about a swing axis, wherein the swing apparatus comprises an arm arrangement comprising a boom and a stick, the method comprising, by a control system:
determining a moment of inertia of the swing apparatus;
determining a maximum allowable swing speed of the swing apparatus rotating about the swing axis based on:
the determined moment of inertia, and
a predetermined maximum angular stopping displacement; and
limiting a maximum operational swing speed of the swing apparatus to the maximum allowable swing speed.

2. The method of claim 1, wherein the maximum allowable swing speed is further based on a determined brake torque of the work vehicle for slowing the rotation of the swing apparatus about the swing axis.

3. The method of claim 1 or 2, wherein the work vehicle comprises at least one sensor and the moment of inertia of the swing apparatus is determined based upon sensor data from the at least one sensor.

4. The method of claim 3, wherein the at least one sensor comprises at least one component position sensor mounted to the swing apparatus and the moment of inertia of the swing apparatus is determined based upon work vehicle component position data from the at least one component position sensor.

5. The method of claim 3, wherein the at least one sensor comprises at least one movement or acceleration sensor mounted to the swing apparatus and the moment of inertia of the swing apparatus is determined based upon movement or acceleration data from the at least one movement or acceleration sensor.

6. The method of claim 3, wherein the at least on sensor comprises one or more of: an inertial measurement unit (IMU); an accelerometer, a gyroscope, a magnetometer; and a pressure sensor.

7. The method of claim 1, wherein the moment of inertia of the swing apparatus is determined based upon configuration data of the work vehicle indicative of the dimensions and/or weight of at least part of the swing apparatus.

8. The method of claim 7, wherein the configuration data includes one or more of: a swing apparatus measurement; a boom measurement; a stick measurement; a main body measurement; a cab measurement; a tool measurement; and a tool type.

9. The method of claim 1, wherein the determined moment of inertia is a static moment of inertia comprising a reference value determined based upon a configuration of the work vehicle.

10. The method of claim 9, wherein the static moment of inertia is determined as the inertia when the arm arrangement of the work vehicle is at maximum extension and/or a tool of the work vehicle is at the maximum operational distance of the tool from the swing axis.

11. The method of claim 9, wherein the work vehicle comprises at least one component position sensor mounted to the swing apparatus and wherein the maximum allowable swing speed is further based upon based upon work vehicle component position data from the at least one component position sensor.

12. The method of claim 1, wherein the method further comprises, by the control system:
changing a configuration and/or a component position of the work vehicle;
redetermining the moment of inertia of the swing apparatus in the changed configuration and/or changed component position;
updating the maximum allowable swing speed of the swing apparatus based on:
the redetermined moment of inertia and
the predetermined maximum angular stopping displacement; and
limiting the maximum operational swing speed of the swing apparatus to the updated maximum allowable swing speed.

13. The method of claim 1, wherein the method further comprises, by the control system:
rotating the swing apparatus about the swing axis at a swing speed equal to or less than the maximum operational swing speed; and/or
overriding a user command to rotate the swing apparatus around the swing axis at a swing speed greater than the maximum operational swing speed.

14. A controller for controlling a work vehicle comprising a swing apparatus rotatable about a swing axis, wherein the swing apparatus comprises an arm arrangement comprising a boom and a stick, the controller being configured to:
determine a moment of inertia of the swing apparatus;
determine a maximum allowable swing speed of the swing apparatus rotating about the swing axis based on:
the determined moment of inertia, and
a predetermined maximum angular stopping displacement; and
limit a maximum operational swing speed of the swing apparatus to the maximum allowable swing speed.

15. A work vehicle comprising:
a swing apparatus rotatable about a swing axis, wherein the swing apparatus comprises an arm arrangement comprising a boom and a stick; and
a control system comprising the controller of claim 14.
